(19) United States
(12) Patent Application Publication
(10) Pub. No.: US 2020/0160348 A1
(43) Pub. Date: May 21, 2020

(54) SERVER DEVICE AND INFORMATION PROCESSING METHOD

(71) Applicant: TOYOTA JIDOSHA KABUSHIKI KAISHA, Toyota-shi (JP)

(72) Inventors: Ryota OSUMI, Toyota-shi (JP); Hiroyuki NAKAJIMA, Toyota-shi (JP); Daijiro MORIWAKI, Toyota-shi (JP); Toshiomi YAMADA, Toyota-shi (JP)

(73) Assignee: TOYOTA JIDOSHA KABUSHIKI KAISHA, Toyota-shi (JP)

(21) Appl. No.: 16/591,678

(22) Filed: Oct. 3, 2019

(30) Foreign Application Priority Data
Nov. 16, 2018 (JP) 2018-215943

(51) Int. Cl. G06Q 30/00; H04W 4/44; G06Q 30/02; G07C 5/00

(52) U.S. Cl. CPC G06Q 30/012; G07C 5/006; G06Q 30/0278; H04W 4/44

(57) ABSTRACT

In a server device, an acquirer acquires history information of a target vehicle. A first derivation unit derives the degree of deterioration of parts of the target vehicle based on the history information acquired by the acquirer. The second derivation unit derives a warranty fee or a warranty condition for a warranty on the parts of the target vehicle according to the degree of deterioration derived by the first derivation unit.

The disclosure of Japanese Patent Application No. 2018-215943 filed on Nov. 16, 2018 including the specification, drawings and abstract is incorporated herein by reference in its entirety.

### BACKGROUND

### 1. Technical Field

The present disclosure relates to a server device and an information processing method for processing information regarding vehicles.

### 2. Description of Related Art

JP 2005-30369 discloses a system that provides a management center with data such as fuel consumption reduced by regenerative power generation from a vehicle capable of regenerative power generation. The management center provides the vehicle owner with a service commensurate with the amount of reduction. It is described that the driver will drive in such a manner that the amount of regenerative power generation increases in expectation of provision of services and the like.

Conventionally, a new vehicle usually comes with a manufacturer warranty for a certain period of time for vehicle parts. The user can extend the manufacturer warranty by paying a warranty fee for the extension. A user who has purchased a used vehicle at a predetermined dealer can also add a manufacturer warranty by paying a warranty fee. However, a warranty fee is, for example, a single price determined for each air volume displacement of a vehicle, and the warranty period is also a single period. Thus, these are irrelevant to the condition of the vehicle. The present inventors have recognized that it is desirable to flexibly set a warranty fee or warranty conditions such as a warranty period in accordance with the condition of the vehicle.

### SUMMARY

The present inventors have recognized this situation and achieved the present embodiment. A purpose of the present embodiment is to provide a server device and an information providing method that allow for a warranty fee or a warranty condition in which the degree of deterioration of parts are reflected to be derived for each vehicle.

A server device according to one embodiment of the present embodiments includes: an acquirer configured to acquire history information of a target vehicle; a first derivation unit configured to derive the degree of deterioration of parts of the target vehicle based on the history information that has been acquired; and a second derivation unit configured to derive a warranty fee or a warranty condition for a warranty on the parts of the target vehicle according to the degree of deterioration that has been derived.

According to this embodiment, it is possible to derive a warranty fee or a warranty condition reflecting the degree of deterioration of parts for each vehicle.

The first derivation unit may derive the degree of deterioration based on a past driving tendency obtained from the history information that has been acquired.

The acquirer may acquire statistical information on history information of a plurality of vehicles, and the first derivation unit may derive the degree of deterioration based on the history information of the target vehicle and the statistical information that have been acquired.

Another embodiment relates to an information processing method. This method includes: acquiring history information of a target vehicle; deriving the degree of deterioration of parts of the target vehicle based on the history information that has been acquired in the acquiring of the history information; and deriving a warranty fee or a warranty condition for a warranty on the parts of the target vehicle according to the degree of deterioration that has been derived in the deriving of the degree of deterioration.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 is a diagram showing the configuration of an information processing system according to the first embodiment;

FIG. 2 is a diagram showing the flow of data in the information processing system of FIG. 1;

FIG. 3 is a block diagram showing the configuration of a second server device of FIG. 1;

FIG. 4 is a diagram showing an example of a relationship between the degree of deterioration of parts and a travel distance of a plurality of vehicles;

FIG. 5 is a flowchart showing the process of the second server device of FIG. 1; and

FIG. 6 is a diagram showing the flow of data in an information processing system according to the third embodiment.

### DETAILED DESCRIPTION

Various embodiments now will be described. The embodiments are illustrative and are not intended to be limiting.

### First Embodiment

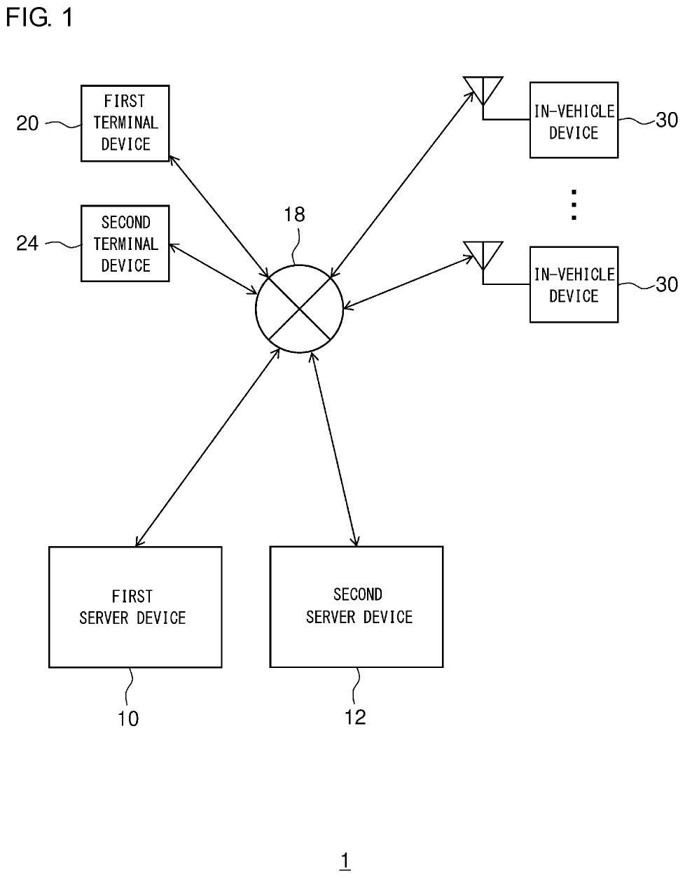

FIG. 1 shows the configuration of an information processing system 1 according to the first embodiment. The information processing system 1 uses the vehicle history information collected from the vehicle to calculate a warranty fee or warranty condition for a manufacturer warranty for the parts of the vehicle.

The information processing system 1 includes a first server device 10, a second server device 12, a first terminal device 20, a second terminal device 24, and a plurality of in-vehicle devices 30.

The in-vehicle devices 30 have a wireless communication function and connect to a network 18 via a wireless base station or a wireless access point (not shown). The second server device 12, the first terminal device 20, and the second terminal device 24 each connect to the network 18 by wired communication or wireless communication. The first server device 10 is connected to the network 18, and the first server device 10 can communicate with the second server device 12, the first terminal device 20, the second terminal device 24, and the in-vehicle devices 30 via the network 18.

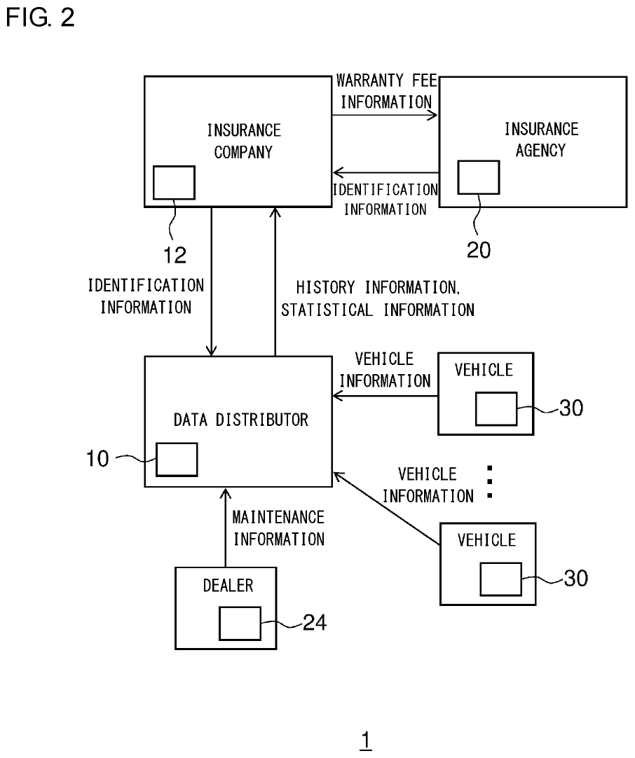

FIG. 2 shows the flow of data in the information processing system 1 of FIG. 1. The first server device 10 is provided at a data center of a data distributor. The data distributor may be a car manufacturer. The second server device 12 is managed by an insurance company that accepts a manufacturer warranty related to vehicle parts.

The first terminal device 20 is installed in an insurance agency such as inside a vehicle dealer. The first terminal device 20 may be a mobile terminal such as a smartphone or a personal computer used by the vehicle owner.

The second terminal device 24 is provided at a facility that performs maintenance and repair of a vehicle such as a dealer, a maintenance facility, or the like. An in-vehicle device 30 is mounted on a vehicle that is a motor vehicle.

Although illustration is omitted, there are a plurality of insurance agencies and dealers, and a plurality of first terminal devices 20 and a plurality of second terminal devices 24 can be provided.

The in-vehicle device 30 periodically acquires vehicle information of the own vehicle and periodically transmits the vehicle information to the first server device 10. The date and time of the acquisition are attached to the vehicle information. The vehicle information is also referred to as CAN data and includes information such as, for example, speed, longitudinal acceleration, lateral acceleration, deceleration, accelerator operation amount, brake operation amount, steering angle, odometer value, safety equipment operational information, various sensor values of the engine, and various sensor values for a driving battery (lithium ion secondary battery). The safety equipment may include, for example, an anti-lock brake system (ABS), a lane keeping assist (LKA), an automatic brake, and the like.

The frequency of acquiring the vehicle information can be appropriately determined through an experiment or the like and may be, for example, once in a few minutes. The frequency of transmitting the vehicle information can be appropriately determined through an experiment or the like and may be, for example, the same as the frequency of acquiring the vehicle information. Identification information for identifying the vehicle is attached to the vehicle information that is transmitted. The identification information is, for example, a vehicle identification number (VIN).

When maintenance of the vehicle is performed at a dealer or the like, the second terminal device 24 receives an input of maintenance information of the vehicle from an employee or the like and transmits the maintenance information that has been received to the first server device 10. The maintenance information includes date and time information for a periodic inspection. The identification information of the vehicle is attached to the maintenance information.

These pieces of information: the vehicle information; and the maintenance information, are generically referred to as history information. The vehicle information and the maintenance information are considered to be associated based on date and time information.

The first server device 10 of the data distributor periodically acquires the history information of a plurality of vehicles from the respective in-vehicle devices 30 of the plurality of vehicles and the second terminal device 24 and accumulates for each vehicle the history information that has been acquired. The first server device 10 stores the history information in association with identification information. The first server device 10 collects history information for each vehicle continuously from when the vehicle is sold as a new car to when the vehicle is scrapped.

The first server device 10 periodically derives statistical information on the history information of the plurality of vehicles for each vehicle classification and stores the derived statistical information for each vehicle classification. The first server device 10 derives statistical information with regard to each vehicle classification for each model year and further derives statistical information with regard to each model year for each travel distance classification. The statistical information includes, for example, an average value of the frequency of sudden braking, sudden acceleration, operation of safety equipment, and the like.

The owner of the vehicle can apply for a fee-based manufacturer warranty at an insurance agency located in the dealer or the like, for example, before the warranty period of the manufacturer warranty on a new vehicle ends, at the time of purchasing a used car, or at the time of vehicle inspection. Using his/her own mobile terminal, the owner of the vehicle may apply through a website that accepts the manufacturer warranty or may apply by executing an application. The manufacturer warranty covers, for example, engines, brakes, power transmission mechanisms, air conditioners, hybrid vehicle driving batteries, and the like and does not cover consumable supplies and oils. Through the manufacturer warranty, if the engine or the like that is covered by the warranty breaks down within the warranty period, the engine or the like can be repaired free of charge if predetermined conditions are met. In this case, insurance money is paid from the insurance company to the dealer.

An employee or the like of the insurance agency that has received an application for manufacturer warranty inputs the identification information of the target vehicle into the first terminal device 20. The first terminal device 20 transmits the identification information of the target vehicle to the second server device 12 of the insurance company. The second server device 12 acquires the identification information of the target vehicle and transmits the acquired identification information to the first server device 10.

The first server device 10 acquires the history information of the target vehicle and the statistical information on the vehicle classification of the target vehicle from the database based on the acquired identification information and provides the acquired history information and statistical information to the second server device 12.

The second server device 12 derives the degree of deterioration of parts of the target vehicle based on the provided history information and statistical information, and derives the warranty fee of the warranty related to the parts of the target vehicle according to the degree of deterioration. The second server device 12 may derive a warranty condition such as a warranty period instead of the warranty fee. The second server device 12 provides warranty fee information to the first terminal device 20.

The first terminal device 20 presents the provided warranty fee to the vehicle owner. Upon agreement to the warranty fee, the vehicle owner applies for the manufacturer warranty. The insurance company can easily set the warranty fee flexibly according to the vehicle condition instead of setting a single price. That is, a warranty fee commensurate with the risk of vehicle failure can be set easily. The owner of the vehicle has an advantage that the warranty fee is likely to become low as long as the owner rides the vehicle with care.

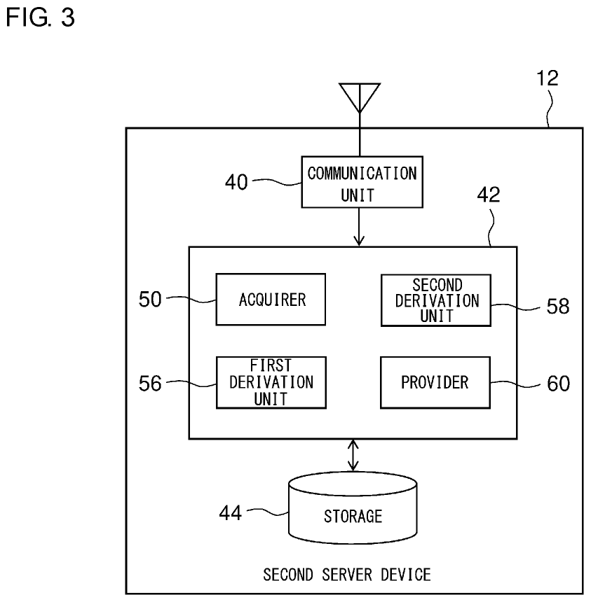

FIG. 3 is a block diagram showing the configuration of the second server device 12 of FIG. 1. The second server device 12 includes a communication unit 40, a processor 42, and a storage 44. The processor 42 includes an acquirer 50, a first derivation unit 56, a second derivation unit 58, and a provider 60.

The configuration of the processor 42 is implemented in hardware by any CPU of a computer, memory or other LSI's, and in software by a program or the like loaded into the memory. The figure depicts functional blocks implemented by the cooperation of hardware and software. Thus, a person skilled in the art should appreciate that there are many ways of accomplishing these functional blocks in various forms in accordance with the components of hardware only, software only, or the combination of both.

The communication unit 40 communicates with the first server device 10 and the first terminal device 20. The communication unit 40 receives the identification information of the target vehicle from the first terminal device 20 and transmits the received identification information to the first server device 10.

The communication unit 40 receives the history information of the target vehicle and the statistical information on the vehicle classification of the target vehicle from the first server device 10 and outputs the received history information and statistical information to the acquirer 50. The acquirer 50 acquires the history information and statistical information of the target vehicle received by the communication unit 40.

The first derivation unit 56 derives the degree of deterioration of parts of the target vehicle based on the history information and statistical information acquired by the acquirer 50. The degree of deterioration of the parts represents the degree of deterioration of all the plurality of parts covered by the warranty such as the engine, the brake, the power transmission mechanism, and the driving battery.

The first derivation unit 56 determines that the degree of deterioration of the parts is at a reference value if the frequency of sudden braking, rapid acceleration, safety equipment operation, and the like of the target vehicle in the past is the same as the average of the frequency (hereinafter referred to as reference frequency) of sudden braking and the like of a plurality of vehicles with a predetermined travel distance whose vehicle classification and model year are the same as those of the target vehicle. Regardless of the travel distance of the target vehicle, the first derivation unit 56 derives the degree of deterioration of the parts to be larger than the reference value as the frequency of the sudden braking of the target vehicle in the past becomes larger than the reference frequency and derives the degree to be smaller than the reference value as the frequency becomes smaller than the reference frequency.

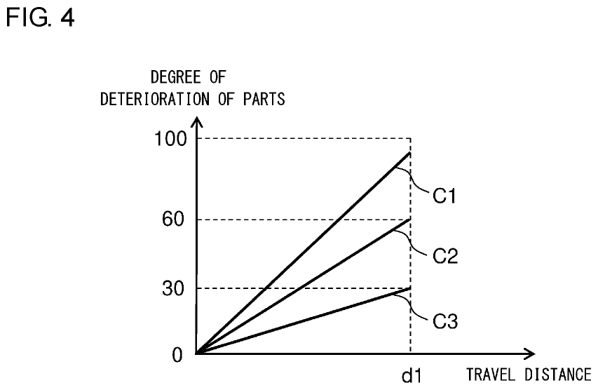

FIG. 4 shows an example of a relationship between the degree of deterioration of parts and a travel distance of a plurality of vehicles C1 through C3. In this example, it is assumed that the degree of deterioration of the parts is proportional to the travel distance. When the travel distance is 0, the degree of deterioration of the parts is 0. As the travel distance increases, the frequency of sudden braking and the like increases, and the degree of deterioration of the parts increases. For example, a predetermined travel distance d1 is set to 100,000 km, a reference value for the degree of deterioration of the parts is set to 50, a limit value therefor is set to 100, an allowable value therefor is set to 60, and a target value therefor is set to 30.

In the vehicle C1, at the predetermined travel distance d1, the frequency of sudden braking and the like is larger than the reference frequency, the driving tendency is rougher than the average, and the degree of deterioration of the parts is 90. In the vehicle C2, at the predetermined travel distance d1, the frequency of sudden braking and the like is close to the reference frequency, the driving tendency is close to the average, and the degree of deterioration of the parts is 60. In the vehicle C3, at the predetermined travel distance d1, the frequency of sudden braking and the like is smaller than the reference frequency, the driving tendency is gentler than the average, and the degree of deterioration of the parts is 30.

The first derivation unit 56 may derive the degree of deterioration of the parts based on the past driving tendency of the target vehicle obtained from the history information and the statistical information that have been acquired. In this case, the first derivation unit 56 determines that the driving tendency becomes rougher as the frequency of sudden braking and the like of the target vehicle becomes larger than the average of the frequency of sudden braking and the like of a plurality of vehicles of the same vehicle classification, the same model year, and the same travel distance classification as those of the target vehicle and determines that the driving tendency becomes gentler as the frequency becomes smaller than the average. The driving tendency is expressed numerically. The first derivation unit 56 derives the degree of deterioration of the parts of the target vehicle to be larger than the average degree of deterioration of the plurality of vehicles of the same vehicle classification, the same model year, and the same travel distance classification as those of the target vehicle as the driving tendency of the target vehicle becomes rougher, and derives the degree of deterioration to be smaller than the average degree of deterioration as the driving tendency becomes gentler.

The second derivation unit 58 derives the warranty fee for the warranty related to the parts of the target vehicle according to the degree of deterioration derived by the first derivation unit 56 based on a predetermined relationship between the degree of deterioration and the warranty fee. The second derivation unit 58 derives the warranty fee to be higher as the degree of deterioration increases. If the degree of deterioration is an average degree of deterioration, a standard warranty fee is applied. The second derivation unit 58 may derive the warranty period to be shorter as the degree of deterioration increases, based on a predetermined relationship between the degree of deterioration and the warranty period. The second derivation unit 58 stores the derived warranty fee or warranty condition in the storage 44 in association with the identification information.

In the example in FIG. 4, the warranty fee for the vehicle C3 is derived to be lower than the warranty fee for the vehicle C2, and the warranty fee for the vehicle C1 is derived to be higher than the warranty fee for the vehicle C2.

The second derivation unit 58 may change the derived warranty fee to be higher based on the maintenance information if the target vehicle has not been regularly inspected for a predetermined period. This is because if the target vehicle has not been periodically inspected for a long period of time, there is a possibility that the target vehicle is more likely to fail.

The provider 60 provides the warranty fee or the warranty condition derived by the second derivation unit 58 to the first terminal device 20 of the insurance agency via the communication unit 40. A process that follows in the first terminal device 20 is as described above.

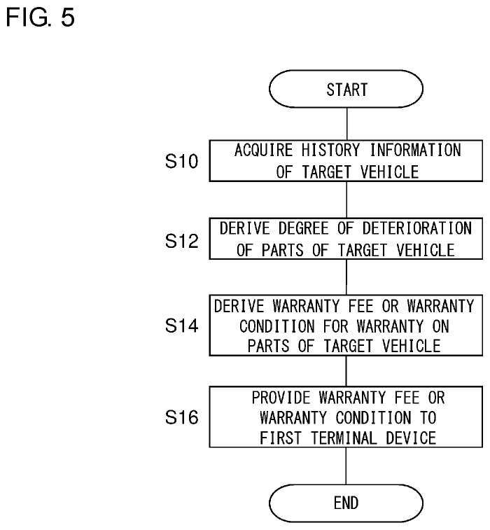

The overall operation of the second server device 12 having the above features will be described next. FIG. 5 is a flowchart showing the process of the second server device 12 of FIG. 1. The process in FIG. 5 is performed every time the identification information of the target vehicle is provided from the first terminal device 20 of the insurance agency. The second server device 12 acquires the history information of the target vehicle from the first server device 10 (S10) and derives the degree of deterioration of the parts of the target vehicle based on the acquired history information (S12). The second server device 12 derives the warranty fee or the warranty condition for the warranty on the parts of the target vehicle according to the derived degree of deterioration (S14) and provides the derived warranty fee or warranty condition to the first terminal device 20 (S16).

According to the present embodiment, it is possible to derive a warranty fee or a warranty condition reflecting the degree of deterioration of parts for each vehicle. The use of the history information allows for the derivation of the degree of deterioration of parts that is difficult to grasp through the external appearance check and/or inspection of the vehicle. The use of the statistical information allows a more appropriate warranty fee or warranty condition to be easily derived.

### Second Embodiment

The second embodiment is different from the first embodiment in that the maintenance information is also used to derive the degree of deterioration of parts. An explanation will be given in the following mainly regarding differences from the first embodiment.

The maintenance information includes replacement information and replacement date and time information of parts such as a driving battery replaced due to the maintenance of the vehicle, and replacement information and replacement date and time information of oil such as an engine oil and a brake fluid, and the like.

The first derivation unit 56 derives the degree of deterioration of the engine based on various sensor values of the engine in the vehicle information and the like. For example, the current power, torque, and the like are compared with respective values obtained at the time of the vehicle was new so as to obtain the degree of deterioration of the engine according to the comparison result. The first derivation unit 56 derives the degree of deterioration of the brake based on the amount of brake operation in the vehicle information. The first derivation unit 56 derives the degree of deterioration of the driving battery based on various sensor values related to the driving battery in the vehicle information.

The first derivation unit 56 sets the sum of the derived degree of deterioration of the engine, the degree of deterioration of the brake, the degree of deterioration of the driving battery, and the like as the degree of deterioration of the parts. That is, the degree of deterioration of the parts is the sum of the respective degrees of deterioration of the plurality of parts covered by the warranty. The degree of deterioration based on the past driving tendency according to the first embodiment may be added to this sum.

For a part or oil for which replacement time recommended by the automobile manufacturer is determined, based on replacement date and time information of the part or oil in the maintenance information of the target vehicle and on the predetermined replacement time, the first derivation unit 56 increases or maintains the derived degree of deterioration of the parts covered by the warranty. The replacement time is set for each part or oil. The replacement time may be set for each vehicle classification. Examples of a part or oil whose replacement time is determined include an engine oil, an oil filter, a brake oil, a spark plug, a lead battery, and the like.

The replacement of an engine oil will be described as an example. The replacement time of the engine oil is, for example, every year or every 15,000 km of traveling, whichever comes first. The first derivation unit 56 maintains the derived degree of deterioration of the engine if the engine oil has been replaced by the replacement time. The first derivation unit 56 increases the derived degree of deterioration of the engine if the engine oil has not been replaced by the replacement time. As the number of times the engine oil was not replaced by the replacement time increases, the first derivation unit 56 may increase the degree of deterioration of the engine on a large scale. This is because if the engine oil has not been properly changed, there is a possibility that the deterioration of the engine is likely to proceed. This makes it possible to provide a warranty fee and the like reflecting whether or not the part or oil for which recommended replacement time is determined has been replaced at an appropriate time.

With regard to a part covered by the warranty, the first derivation unit 56 derives the degree of deterioration of the part covered by the warranty, based on the vehicle information obtained after the replacement date and time related to the part covered by the warranty of the target vehicle that has been replaced.

For example, when the driving battery has been replaced, the first derivation unit 56 derives the degree of deterioration of the driving battery based on the vehicle information obtained after the replacement date and time related to the driving battery. This is because when the driving battery has been replaced, the vehicle information on a driving battery before the replacement is irrelevant to the degree of deterioration of the driving battery after the replacement. This allows for the derivation of an accurate degree of deterioration regarding the part that has been replaced, and a more accurate warranty fee or warranty condition can be provided.

According to the present embodiment, a highly accurate warranty fee or warranty condition reflecting the maintenance status of the vehicle can be provided.

### Third Embodiment

The third embodiment is different from the first embodiment in that the first server device 10 derives a warranty fee and the like. An explanation will be given in the following mainly regarding differences from the first embodiment.

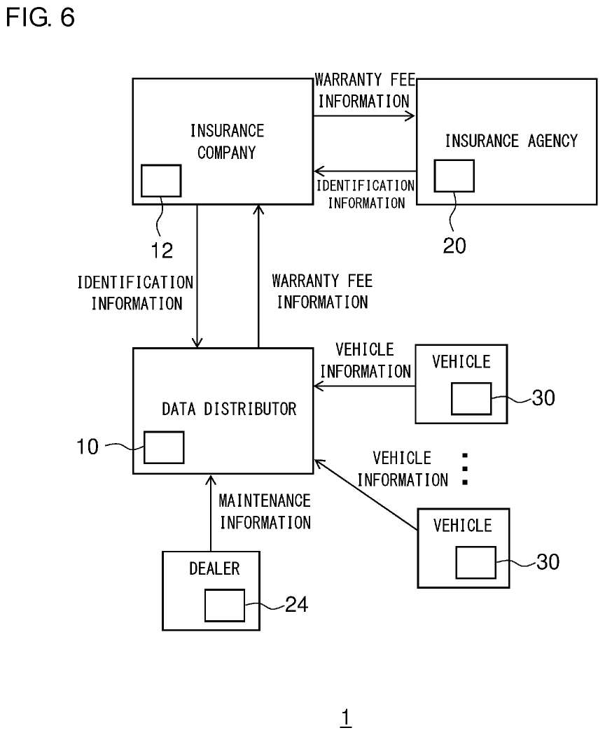

FIG. 6 shows the flow of data in the information processing system 1 according to the third embodiment. The second server device 12 acquires the identification information of the target vehicle from the first terminal device 20 and transmits the acquired identification information to the first server device 10.

The first server device 10 acquires the history information of the target vehicle and the statistical information on the vehicle classification of the target vehicle from the database based on the acquired identification information and derives the degree of deterioration of the parts of the target vehicle based on the acquired history information and statistical information. The first server device 10 derives the warranty fee or the warranty condition for the warranty on the parts of the target vehicle according to the derived degree of deterioration. The first server device 10 provides warranty fee information to the second server device 12. The second server device 12 provides the provided warranty fee information to the first terminal device 20. The first server device 10 can be formed in the same way as shown in FIG. 3.

According to the present embodiment, the degree of freedom of the configuration of the information processing system 1 can be improved.

Described above is an explanation based on exemplary embodiments. The embodiments are intended to be illustrative only, and it will be obvious to those skilled in the art that various modifications to a combination of constituting elements or processes could be developed and that such modifications also fall within the scope of the present disclosure.

In the embodiment, an example has been described where a warranty fee and the like are derived when the identification information of a target vehicle is acquired. Alternatively, the acquirer 50 may periodically acquire history information and statistical information of a plurality of vehicles, and the first derivation unit 56 may periodically derive the driving tendency and the degree of deterioration of parts for each of the plurality of vehicles. The second derivation unit 58 may periodically derive a predicted value of the next warranty fee or the like for each of the plurality of vehicles, and the provider 60 may provide the derived driving tendency and the predicted value of the next warranty fee to an in-vehicle device 30 of the corresponding vehicle or a portable terminal of the vehicle owner or the like. This exemplary variation allows the vehicle owner to understand the driving tendency and the outlook for the warranty fee.

The first derivation unit 56 may derive the degree of deterioration of parts without using statistical information. In this exemplary variation, the process can be simplified, and the amount of data to be stored can be reduced. Further, the first server device 10 may derive statistical information on history information of a plurality of vehicles for each model. In this case, the first derivation unit 56 of the second server device 12 needs to perform the above-mentioned process using a model instead of a vehicle classification.

What is claimed is:

1. A server device comprising:
an acquirer configured to acquire history information of a target vehicle;
a first derivation unit configured to derive the degree of deterioration of parts of the target vehicle based on the history information that has been acquired; and
a second derivation unit configured to derive a warranty fee or a warranty condition for a warranty on the parts of the target vehicle according to the degree of deterioration that has been derived.

2. The server device according to claim 1, wherein the first derivation unit derives the degree of deterioration based on a past driving tendency obtained from the history information that has been acquired.

3. The server device according to claim 1, wherein
the acquirer acquires statistical information on history information of a plurality of vehicles, and
the first derivation unit derives the degree of deterioration based on the history information of the target vehicle and the statistical information that have been acquired.

4. An information processing method comprising:
acquiring history information of a target vehicle;
deriving the degree of deterioration of parts of the target vehicle based on the history information that has been acquired in the acquiring of the history information; and
deriving a warranty fee or a warranty condition for a warranty on the parts of the target vehicle according to the degree of deterioration that has been derived in the deriving of the degree of deterioration.
